(19) United States
(12) Patent Application Publication
(10) Pub. No.: US 2026/0226914 A1
(43) Pub. Date: Aug. 6, 2026

(54) BLADING SYSTEM FOR AXIAL COMPRESSORS WITH AXIALLY OPPOSING BASE MERGED DOUBLE TRIANGULAR PRISM DEVICE BLADES

(71) Applicant: SPACEROLLS AEROSPACE TECHNOLOGIES PRIVATE LIMITED, Bangalore, Karnataka (IN)

(72) Inventor: Mohammed RASHEED C, Perintalmanna (IN)

(73) Assignee: SPACEROLLS AEROSPACE TECHNOLOGIES PRIVATE LIMITED, Bangalore, Karnataka (IN)

(21) Appl. No.: 19/151,291

(22) PCT Filed: Jan. 27, 2024
(86) PCT No.: PCT/IB2024/050775

§ 371 Date: Jul. 25, 2025

(30) Foreign Application Priority Data
Jan. 27, 2023 (IN) 202241043132

(51) Int. Cl. F04D 29/32; F04D 19/00; F04D 29/66

(52) U.S. Cl. CPC F04D 29/324; F04D 19/00; F04D 29/667

(57) ABSTRACT

Introducing the ABMP Compressor, a cutting-edge axial flow compressor technology set to transform gas turbine jet engines and find applications across various domains. Our innovation focuses on optimizing compression ratios and maximizing energy extraction, ensuring efficient operation in diverse conditions. The ABMP Compressor offers adaptability, allowing strategic adjustments for peak performance. Embracing environmental responsibility, it supports sustainable fuels and cleaner energy initiatives. Its seamless integration with turbofans enhances performance and reduces vibrations in gas turbine jet engines and other applications. Engineered to prevent operational disruptions, the compressor mitigates compression stall and surge, promoting stable combustion efficiency with uniform fuel distribution and stable flame fronts. With extended operational limits, reduced wear and tear, and overall system-wide performance enhancement, the ABMP Compressor signifies a transformative solution in the evolving landscape of propulsion systems.

### FIELD OF THE INVENTION

The present invention pertains to fluid mechanics and aerodynamics, specifically addressing total pressure enhancement in axial flow compressors. It achieves this by mitigating energy losses, vibrations, and unwanted blade excitations resulting from static pressure interactions. The innovation minimizes cascade effects from conventional pressure convex and concave blade sides, secondary flow losses, and shockwave losses. Additionally, the invention involves imposing strain on wakes in strong velocity fields, employing a reversible recovery process, and compressing wakes downstream to recover total pressure losses. This approach reduces frictional losses and acoustic levels caused by high turbulence, early shockwaves, and interactions with extended blade surfaces. The non-distorted flow improves gas dynamics, combustion efficiency, and stability, resulting in enhanced overall performance, stability, and efficiency for downstream components in gas turbine jet engines and various applications.

### BACKGROUND OF INVENTION

The technical problem addressed by this invention are as follows:
1. Comparatively less power to weight ratio due to less pressure raise per stage
2. Comparatively less fuel-efficient gas turbine engines
3. In the existing technology, a significant axial velocity deceleration occurs as the flow traverses the stator blades from the rotor blades. This deceleration is attributed to the use of highly cambered blades with convex pressure sides and concave suction sides. The necessity for increased blade camber to elevate static pressure leads to a compromise, particularly at lower RPMs, where it results in a deterioration of axial velocity head. Furthermore, at higher RPMs, the early shockwave formation, not followed by a robust velocity field, induces high boundary layer separations and turbulent air molecule interactions with extended blade surfaces. This, in turn, results in substantial velocity head losses.
4. High hub solidity (o), both pitch of rotors and pitch of stators decreases leads to very high solidity results in high complexity of compressor design as well as the flow will become more three dimensional through the blade passage of both the rotors and stators will leads to the creation of passage vortices, corner drag, horseshoe vortices and stagnation losses due to high cambered blades (convex pressure side and concave suction side-due to this trend, need more cambered blades to have more static pressure raise) altogether the dimensions of the flow paths of the domains in between consecutive rotor blades and stator blades decreases due to the decrease in pitch while attempting to further raise the pressure, the upper and lower pitch ratio limits should be around 0.6 and 1.5 respectively, moreover the designers desired to keep the pitch ratio around unity, this will results in addition of a rotor blade to add an extra stator blade which will again increase the solidity to an undesired quantity. High hub solidity and conventional pressure concave side and suction convex sides of the blades together will trigger the cascade effects, three dimensional flows, stagnation losses, losses due to secondary flows like flow path vortices, horseshoe vortices together with the losses associated with it. The flow over the hub will be a decelerated flow in common; corner drag, horseshoe vortex are the major sources of losses in the hub zones.
5. The pursuit of maximum pressure output from stages, where the count of stators and rotors equals, coupled with comparable passage domains of rotors and stators, can lead to challenges such as acoustic resonance problems and unstable flows. The manifestation of acoustic resonance waves poses a significant threat to the engine's performance, integrity, and overall lifespan.
6. Total pressure losses due to shockwaves. No total pressure recovery methods. The early shockwaves (shockwave forms at the flow entry location of the stators) were subjected to high energy loss.
7. The presence of non-uniform low velocity or reduced suction at the inlet contributes to increased nacelle drag, flow blockages, and diminished mass flow rate entry.
8. Increased complexity, wear and tear, and heightened maintenance demands arise in axial compressors aiming to achieve the necessary pressure boost, as they incorporate a greater number of rotating components in their efforts to attain and maintain optimum pressure levels.
9. Probability of higher aerodynamic and operational instabilities like p-factor aerodynamics and the shear stress created on individual axial flow compressor blades due to the centre pressure travel of asymmetric airfoils of the blades.
10. The likelihood of premature boundary layer separation occurring over both stators and rotors is significantly elevated due to the pronounced curvature of blades at higher axial velocities and RPMs. This inherent limitation in current technology serves as a primary factor for early compressor stall, subsequent surge, and establishes upper operational constraints that directly impact the overall engine output and performance. As the flow traverses through the curved and twisted blades, asymmetric boundary layers form on their surfaces, fostering the robust development of passage vortex. Additionally, the pressure gradient induces the development of end wall boundary layers over the hub and casing of the compressor, thereby contributing to the intricate evolution of three-dimensional flow.
11. Wear and tear due to ramming of rotor blade tip into the casing by aging will reduce the life expectancy of the engine. Tip leakages will deteriorate the performance of axial compressors. If we increase the gap between rotor blade tip and casing, tip leakages will increase and probability of ramming will decrease, but if we decrease the gap, tip leakages will decrease, probability of wear and tear will increase. Moreover, vibrations, blade excitations, tip vortices and tip stresses due to blade movements with the flat top of the rotor blades.
12. High amplitude vibrations, blade excitations, tip vortices and tonal nodes triggering from the tip of the rotating rotor blades due to the flat tip and sharp/slightly blunted tips of the rotor blades rotating at high RPMs in high axial velocities.
13. High stress levels on rotor blades when it rotates at higher RPM with a flat plate/concave cambered wet area which is a major limiting factor for the current technology. The turbine power to run the compressor is also high which compromises some level of output thrust of the engine as well.
14. Sound pollution with high decibel acoustic waves due to high vibrations and imbalanced blade excitations. Continuous interaction of rotor static pressure fields with the stator pressure fields occurs due to rotation, generating high acoustic levels.
15. Wakes from the rotors and stators are viscously dissipated/mixed, which is irreversible and results in total pressure losses rather than imposing inviscid strain on fluid particles by the velocity fields of rotors and stators, this is due to the lack of strong velocity fields at the inlet of both rotors and stators when the wake transported through the flow path of stators and rotors in the current technology.
16. Suboptimal performance of both the axial flow compressor and the gas turbine jet engine as a cohesive unit.

### OBJECT OF THE INVENTION

Axial flow compressors play a crucial role in pressurizing incoming air, particularly in applications like gas turbine jet engines. Traditionally, the conversion of dynamic pressure from rotors to static pressure over stators has been the established approach. However, the inherent complexity of systems with numerous rotating parts prompted the need for enhanced effectiveness in pressure generation while minimizing losses. This invention aims to achieve precisely that by optimizing subcomponents such as stators and rotors, resulting in improved overall system output compared to conventional methods.

The rotor's consistent peripheral velocity induces a swirling nature in the axial flow, leading to diffusion in both stators and rotors. As the axial flow, combined with peripheral velocity components, traverses the stator vanes, it undergoes a transformation from dynamic pressure head to static pressure head, reducing axial velocity and introducing system challenges and losses. The density increase across successive stages contributes to axial velocity reduction. In conventional technology, these characteristics limit the output range, necessitating more stages for increased output. Furthermore, total pressure rise is constrained, with no dedicated process for recovery after multiple losses. The newly introduced blading system addresses several shortcomings of conventional axial flow compressor technology. It aims to minimize or eliminate flow path vortices, horseshoe vortices, stagnation losses, shockwave losses, and secondary flow losses arising from cascade effects. Additionally, concerns such as acoustic levels, vibrations, blade excitations, and blade tip tonal nodes are systematically addressed. The three-dimensional nature of flow in the compressor is strategically managed to minimize energy losses.

In contrast to conventional technology, the new blading system is designed to keep losses at a minimum or eliminate them entirely. This approach enables an increase in total pressure output, comprising static and dynamic pressure. The rise in static pressure is achieved by minimizing axial velocity deceleration, thereby reducing the need for adding numerous stages to achieve higher system output. Through advancements in design and processes, the newly introduced blading system effectively resolves the mentioned challenges, elevating it beyond the basic level of conventional axial flow compressor technology.

### SUMMARY OF THE INVENTION

1. The power-to-weight ratio issue, attributed to less pressure raise per stage, is effectively addressed through an innovative blading system for axial flow compressors and the resultant innovative process:
   Converging-Diverging Flow Process: The implementation of converging-diverging flow paths, facilitated by the defined blade structures, significantly reduces flow losses and enhances total pressure output. This results in improved power generation efficiency.
   Comprehensive Axial Flow Compressor Design: The axial flow compressor, incorporating the advanced blade structures, ensures a holistic solution to the power-to-weight ratio concern. This design optimization contributes to increased overall performance and efficiency, addressing the limitations associated with less pressure raise per stage.
2. Less fuel-efficient gas turbine engines are the engines available in the current market with the current axial compressor technology is a serious concern when our requirements are being broader than ever before, the demand for fuel rises due to hikes in price and limited stocks resulting in need of high fuel-efficient engines. Through this invention, we will be able to introduce a new revolutionizing architecture for the jet engines as a replacement for the current technology that will solve this problem. We will be able to generate more pressure, and less reduction in axial velocity with less weight. The new architecture for the axial compressors we are introducing here will be higher efficiency in terms of required output than the current model which is currently available in the market.
3. The novel axial flow compressor revolutionizes existing technology by introducing a diamond aerofoil design, a converging flow path with bumps, and optimized shock-expansion patterns. This innovative approach minimizes axial velocity deceleration challenges associated with conventional highly cambered blades. The diamond aerofoil design ensures compressed accelerated flow with high Axial Velocity Density Ratio (AVDR), reducing compromises between blade camber and static pressure elevation. The converging flow path and bumps strategically weaken shockwaves, prevent early boundary layer separations, and maintain a robust velocity field. The delayed trailing oblique shock waves further mitigate energy losses, turbulence, and turbulent air-blade interactions. These advancements collectively enhance total pressure recovery, reducing axial velocity head losses and ensuring optimal compressor performance across a range of RPMs.
4. Solidity, measured as the ratio of blade chord length to the space between blades, impacts axial flow compressors. Higher solidity leads to losses and reduced polytropic efficiency. The current architecture faces limitations with high solidity, causing cascade effects and flow path issues. An innovative solution is needed, introducing a design with dedicated acceleration and deceleration portions, acting as both rotor and stator. This design enhances total and static pressure, rotor inlet velocity, and stator outlet velocity with minimal losses. Unlike conventional approaches, it maintains low hub solidity, avoiding issues like corner drag and horseshoe vortices. The proposed design minimizes three-dimensional flow in axial compressors, achieving higher pressure ratios with reduced three-dimensionality, contrary to the conventional trend.
5. Due to the conventional concave pressure side and convex suction side of the blades, the probability of secondary flows encountered will result in three-dimensional flow pattern and the losses, blockage followed by it. Each conventional blades will be affected by the presence of each other is called cascade effect. Through the newly introduced blading system and devices, we are solving these issues by bringing complete suction portion at the front and static pressure portion at the rear, suction volume and the pressure volume is formed by the combination of adjacent blades and the devices together, so there are no secondary flows and cascade effects present in this new blading system. Moreover, the close arrangement of new blades does not influence/affect each other adverse. Instead of adverse effects due to blades, it will benefit the performance of the whole engine. This is what is required to reduce the number of stages successfully providing less complex flow.
6. The total pressure losses are considerably very high around a shockwave and there is no dedicated process to recover the lost total pressure in the current system. Through the new blading system, the total pressure can be enhanced through the work-total pressure (total energy conservation) method. Thus, the total pressure of the flow is recovered and enhanced. The shockwave formation is far from the flow entry point of the stators; thus, the shockwave losses/total energy losses of the flow is substantially reduced incorporated with the total pressure recovery method.
7. The novel axial flow compressors address non-uniform low velocity at the inlet by ensuring a more uniform and non-distorted flow over the axial and peripheral regions. This design improvement leads to enhanced mass flow rate entry, reduced nacelle drags, and minimized flow blockage, contributing to overall improved engine performance.
8. Sound pollution with high decibel acoustic waves due to high vibrations and imbalanced blade excitations. Continuous interaction of rotors static pressure fields with the stators static pressure fields occurs due to rotations that generate high acoustic levels in the current blading system of axial compressors. The convex suction side and concave pressure sides of the blades in the current technology is the reason for the hike in acoustic levels due to the continuous interaction of static pressure fields. Through the invention and the blading system we are introducing here, both the suction side and the pressure sides are formed by the combination of adjacent blades, by forming converging and diverging flow paths. Thus, the suction side and pressure sides are alternatively formed throughout the compressor. There won't be any pressure-pressure interaction of the rotors and stators possible in the new blading system. as a result, the acoustic levels of the compressor will be very lower compared with the current model of axial compressors. Reducing sound pollution is very important in the aviation industry as well in industrial power generation engines, which operate in the ground. The vibration levels and imbalanced blade excitations can be reduced to a big extent in the new blading system. The static pressure field will be formed after the half of the chord, near to the centre of mass (maximum thickness line) of the blades. The vibrations cannot yield high amplitudes. Thus, the vibrations cannot effectively excite the blades which will result in very low vibration levels.
9 Higher aerodynamic and operational instabilities is limiting the capabilities of an engine which will limit an engine to be operated at a wide spectrum of velocities and at different manoeuvres. Through this new blading system, the pressure generation is not related to camber angles or relative stator-rotor flow angles. The blade flow is undisturbed by the dimensions of flow paths. This will relax both aerodynamic and operational instabilities of an engine.
10. The proposed solution involves implementing an innovative blade design for both stators and rotors in transonic/conventional axial flow compressors. This design incorporates symmetrical diamond airfoils with an imaginary straight chord line, aiming to control flow acceleration and minimize energy losses through the precise induction of a Prandtl-Meyer expansion wave and subsequent flow compression via an oblique shockwave. Additionally, utilizing an elongated cantilever aerodynamic blade with converging-diverging characteristics, especially for rotors, contributes to superior aerodynamic efficiency and total pressure output. The optimized rotor blade configuration further minimizes flow distortion, accelerates axial velocity component, and fosters uniformity across radial locations, addressing the challenges associated with early boundary layer separation, especially at higher axial velocities and RPMs. This comprehensive solution aims to improve overall engine performance, mitigate compressor stall, and extend operational limits.
11. The challenges related to wear and tear due to aging, tip leakages, and performance degradation in axial compressors can be mitigated through key design features. Optimizing the length of rotor blades, employing a key and hole configuration for enhanced stability, and implementing a converging-diverging flow path design can collectively address these issues. These solutions aim to reduce vibrations, minimize tip leakages, and enhance overall efficiency, contributing to prolonged engine life and improved performance. Balancing the gap between rotor blade tips and casing is crucial, as increasing it may reduce the probability of wear and tear but increase tip leakages, while decreasing it may decrease tip leakages but increase the likelihood of wear and tear. This comprehensive approach seeks to enhance the reliability and longevity of axial compressors in various operational conditions.
12. To effectively address challenges related to high-amplitude vibrations, blade excitations, tip vortices, and tonal nodes in rotating rotor blades, an innovative solution calls for a comprehensive redesign of the blade structure. The proposed design incorporates a unique feature at the blade tips, involving the integration of a half or a specified portion of a double cone. This double cone is carefully designed with a specific axial length distribution across distinct segments.

The cross-section of the blade structure is reimagined to adopt a diamond airfoil, providing a solid foundation for the incorporation of the double cone. The defined portion of the double cone is seamlessly integrated into this base, with a strategic placement that aligns the centre of mass at the maximum thickness cross-sectional area. This strategic positioning serves to minimize vibrations effectively.

Furthermore, the design takes into account the reduction of stagnation points, a key element in mitigating excitations caused by incoming flow. To achieve this, the blade structure incorporates a slanted edge, adding an extra layer of effectiveness in addressing the aforementioned issues. In a parallel effort to optimize blade structure, a focus is placed on the length distribution along the flow path volume. Specifically, rotor blades are optimized with an increased length at the throat section and a minimized length at the leading and trailing edges. This targeted optimization proves crucial in mitigating tonal nodes, tip leakages, and other adverse effects associated with high RPMs and axial velocities.

By combining these design enhancements, the holistic approach seeks to not only address the immediate challenges posed by high-amplitude vibrations and excitations but also to elevate the overall efficiency and performance of transonic/conventional axial flow compressors. This synergistic integration of innovative features promises to usher in a new era of rotor blade design, ensuring enhanced stability, reduced aerodynamic disturbances, and improved compressive performance in rotating systems.
13. Our pioneering solution tackles the challenge of high stress levels on rotor blades during high-speed rotation in current technology. The introduction of a specialized blade structure, incorporating a symmetrical diamond airfoil and optimized lengths, not only mitigates stress but also reduces the turbine power needed for compressor operation. This innovation enhances blade durability and improves overall engine efficiency by optimizing power consumption.
14. Sound pollution, originating from the intense vibrations and imbalanced blade excitations in the current axial compressor model, poses a significant concern due to high-decibel acoustic waves. The continuous interaction between rotor static pressure fields and stator pressure fields, fueled by rotation, leads to elevated acoustic levels. The existing technology's convex suction side and concave pressure sides of the blades contribute to this acoustic increase through uninterrupted interaction. Our innovative blading system addresses these issues by configuring suction and pressure sides through the amalgamation of adjacent blades, creating converging and diverging flow paths. This strategic alteration prevents pressure-pressure interaction between rotors and stators, resulting in substantially lower acoustic levels compared to conventional axial compressors. Moreover, the novel blading system actively contributes to reducing sound pollution by thinning the boundary layer, minimizing turbulence, and diminishing interactions between turbulent air molecules and the blade surface. This comprehensive approach results in further decreased acoustic levels, making it advantageous not only for aviation but also for ground-based industrial power generation engines. Furthermore, the introduced system plays a pivotal role in minimizing vibration levels and imbalanced blade excitations. The static pressure field formed after half of the chord near the center of mass (maximum thickness line) of the blades prevents vibrations from reaching high amplitudes, ensuring very low vibration levels. This holistic solution addresses multiple aspects of sound and vibration issues, making it a noteworthy advancement in compressor technology.
15. In current technology, wakes from rotors and stators suffer irreversible total pressure losses due to viscous dissipation. Our innovative blading system introduces a unique approach-utilizing strong velocity fields at the entry flow path for both rotors and stators. This enables efficient recovery of total pressure losses incurred during wake formation. The distinctive design, featuring a suction volume followed by the pressure side, eliminates viscous dissipation within axial compressors. Additionally, the converging-diverging flow paths in our invention compress the wakes, enhancing overall performance and minimizing losses. The integration of wake dilution with total pressure recovery at the throat, where the Prandtl-Meyer expansion forms, results in a higher velocity field that strains over the wakes, effectively solving wake issues and recovering energy.
16. The poor performance of the axial flow compressor and gas turbine jet engine as a whole is addressed through the introduced innovations. These advancements lead to improved aerodynamic and operational stability, expanding the engine's operational range near the surge line. The innovative device and process enhance the mass flow rate, resulting in increased pressure and sustained velocity with minimal losses. This, in turn, contributes to better efficiency, performance, and overall stability of the engine.

### BRIEF DESCRIPTION OF DRAWINGS

### Conventional Airfoils and Blades:

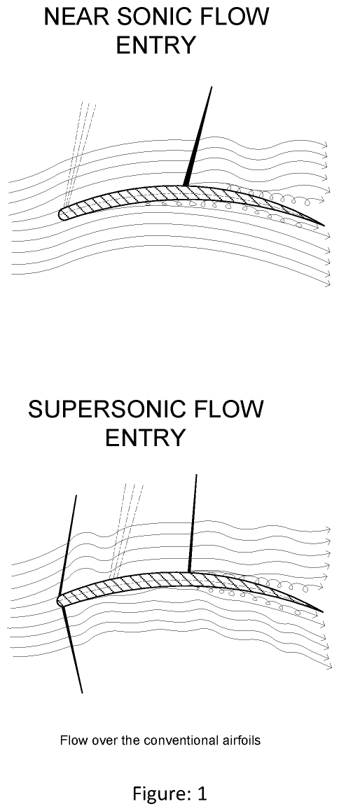

FIG. 1 illustrates a conventional airfoil characterized by a cambered chord line, resulting in a pressure side and a suction side. In subsonic flow conditions and as the flow approaches supersonic speeds, acceleration occurs, leading to the formation of a Prandtl-Meyer expansion wave near the leading edge. This wave further accelerates the flow, reaching sonic conditions. Downstream, a normal shockwave forms at an early zone of the airfoil which is at an early point/nearby quarter chord point from the leading edge of the chord line of the airfoil, decelerating the flow back to subsonic speeds. However, boundary layer separations and wake formations can occur, causing flow disturbances. The bottom surface experiences deceleration due to the velocity decrease on the pressure side.

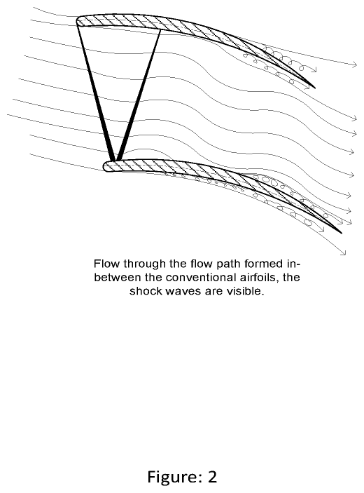

FIG. 2 depicts the scenario of supersonic flow entry. A slight oblique shockwave forms at the leading edge of the airfoil/blade, followed by a Prandtl-Meyer expansion wave that accelerates the flow. An early normal shockwave then decelerates the flow to subsonic speeds and compresses it. Boundary layer separations and flow disturbances arise as the flow layer detaches over the surface. The bottom surface experiences deceleration due to the velocity decrease on the pressure side,

### Diamond Airfoils and Blades:

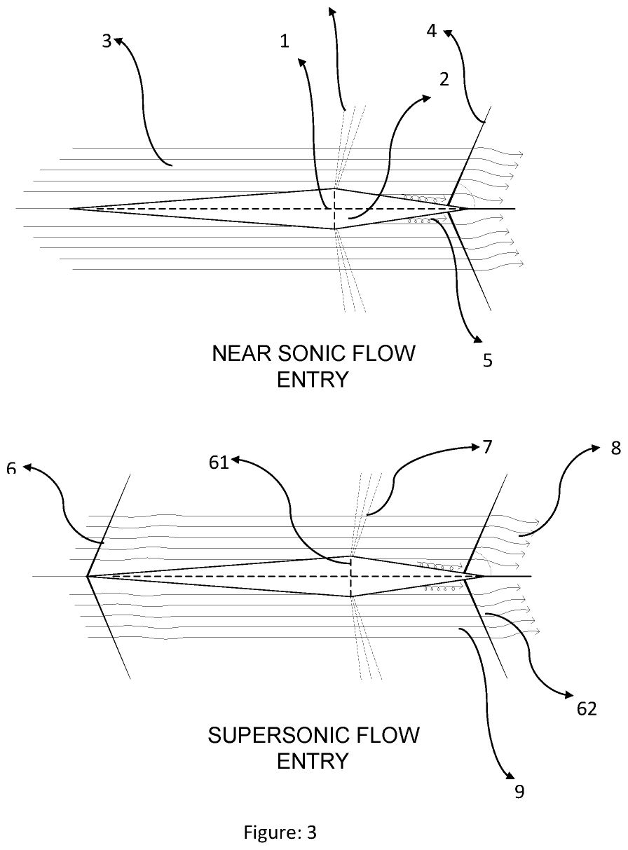

FIG. 3 shows the flow passes over a diamond airfoil/blade which is symmetrical at the both sides from its straight chord line is at subsonic flow conditions and as the flow approaches supersonic speeds, a steep acceleration occurs due to the converging nature of the blade from the leading edge till the maximum thickness point of the airfoil/blades. A Prandtl Meyer expansion wave forms at the maximum thickness point of the diamond airfoil, which leads to the acceleration of the flow to sonic/supersonic speeds. An oblique shockwave which compresses the air forms at the rear zone of the airfoil which is at a delayed point of the chord line of the airfoil,

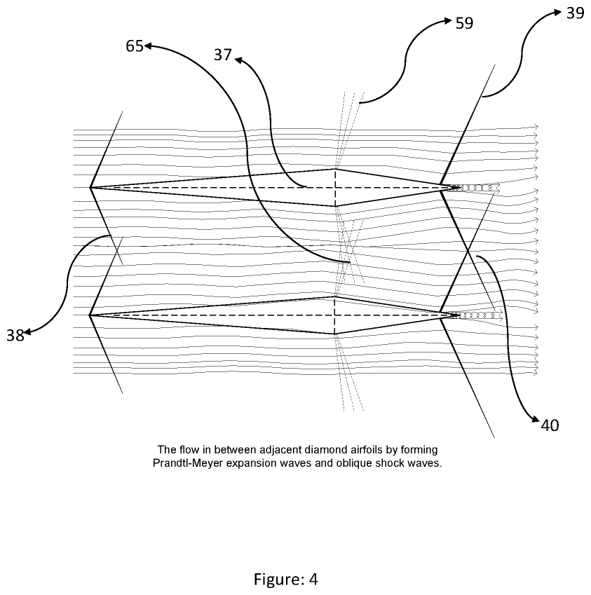

FIG. 4 depicts the flow passing over a diamond airfoil/blade which is symmetrical at the both sides from its straight chord line is at supersonic flow condition, an oblique leading edge shockwave form. Then the flow after the leading-edge shockwave accelerates steeply till the maximum thickness point of the diamond airfoil, which leads the flow attains sonic/supersonic speeds, the flow gets compressed by an oblique shock wave forms at the rear zone of the airfoil which is at a delayed point of the chord line of the airfoil. The flow layer over the diamond airfoil will get detached post the rear most oblique shock waves. But comparatively lesser boundary layer separations and turbulences due to delayed oblique shockwave in contrast to early normal shockwave found in conventional airfoils.

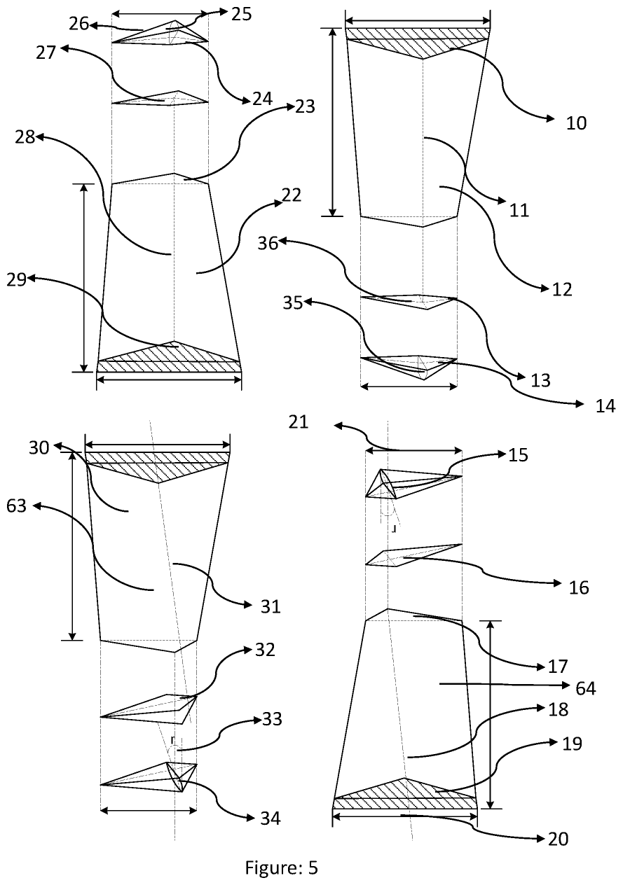

FIG. 5 illustrates an elongated cantilever aerodynamic blade, constituting a continuous structure characterized by a cross-section shaped as a diamond airfoil or the geometry of axially opposed double triangular prisms merging at their imaginary bases. The free horizontal tip of the blade converges with a segment of a double cone. In this context, the horizon is defined as the plane parallel to the axis of rotation. The double cone is a continuous structure of axially opposed double cones merging at their imaginary bases, with a segment formed by truncating it through an imaginary plane parallel to its axis. The merge of the defined cantilever blade structure and the segment of the double cone occurs in the same plane formed by the truncation of the double cone, and where the straight chord line of the cantilever blade structure meets an imaginary line passing through both vortices of the maximum thickness line.

Both the cantilever blade structure and the segment of the double cones seamlessly merge at designated imaginary planes, forming a continuous cantilever blade structure that generates a converging-diverging effect on the surrounding flow. This design enhances aerodynamic efficiency and total pressure output by minimizing energy losses, including the mitigation of boundary layer separations and turbulence.

This figure complements claims 2, 3, 4, and 6, incorporating additional features such as varying proportions of cross-sectional diamond airfoils between the two opposing imaginary triangles and total size variations for different radial locations from the hub to the tip. These variations are attributed to the decreasing radial velocity gradient from the tip to the hub for rotors and vice versa for stators, promoting uniformity across radial locations and reducing the need for high differential stagger angles.

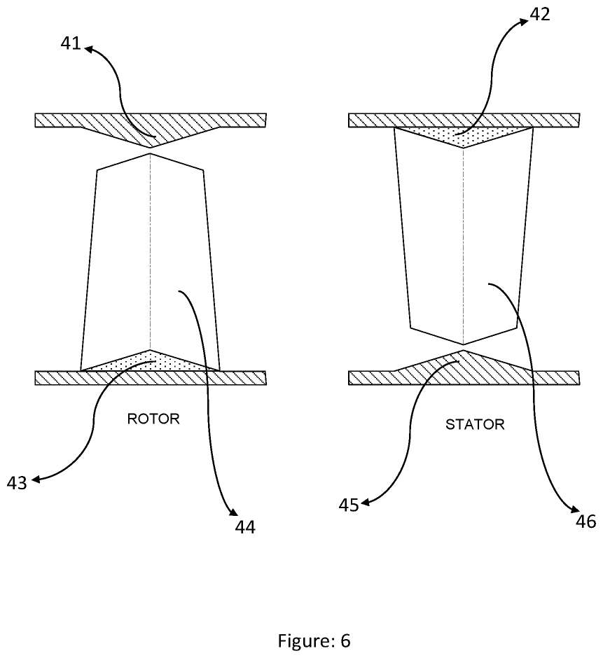

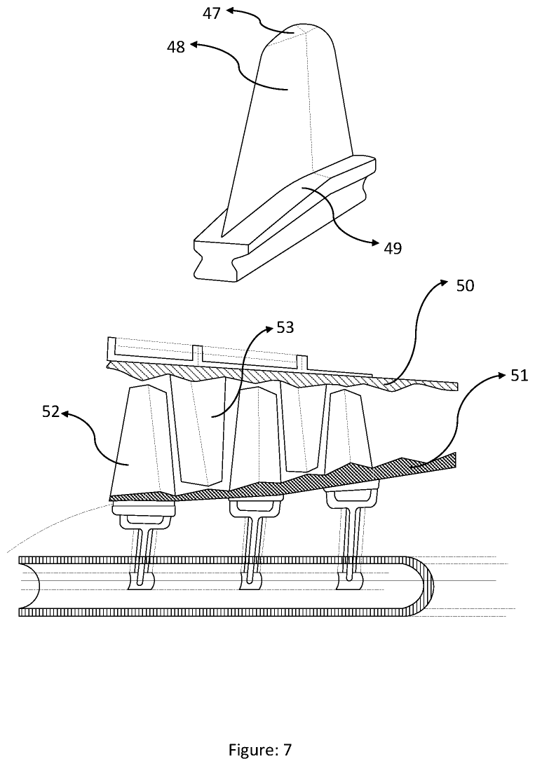

FIG. 6 and FIG. 7 illustrate the hub and tip walls of both rotor and stator sections with a design featuring an initial positive slope leading to a minimum throat cross-sectional area. This is followed by a negative slope after the minimum throat, resulting in a horizontal converging-diverging flow path between the rotor blades. The purpose of this specific configuration is to minimize energy losses and promote wake dilution, facilitating total energy recovery by effectively straining over incoming wakes at the high-velocity field of the throat. The incorporation of converging-diverging flow paths significantly enhances the overall efficiency of the system.

This configuration aligns with the content of claim 7, emphasizing the strategic design of hub and tip walls to optimize flow dynamics, minimize energy losses, and promote total energy recovery, contributing to the improved efficiency of transonic/conventional axial flow compressors.

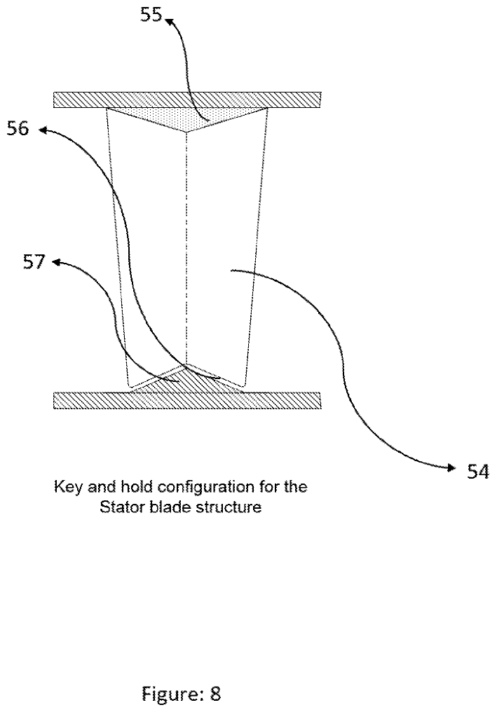

FIG. 8 depicts the utilization of a key and hole configuration (54, 56, 57) within the blade structure as described in claim 3. This configuration involves a precise fit of the stator blade tip (56) into a void over the hub surface (57). The arrangement is achieved through a meticulously designed profile, featuring a positive slope, followed by a minimum length point, and then a negative slope on the stator blade tips (56), and a corresponding arrangement on the hub surface (57). This carefully engineered configuration ensures a secure attachment of stator blades to the hub surface.

The key and hole design not only enhances the blade structure's resistance to vibrations but also effectively dampens effects during blade fluttering. This contributes to an increased level of reliability in axial flow compressors and gas turbine jet engines. Overall, FIG. 8 aligns with the content of claim 8, emphasizing the importance of this configuration for improving the stability and reliability of the blade structure in the specified applications.

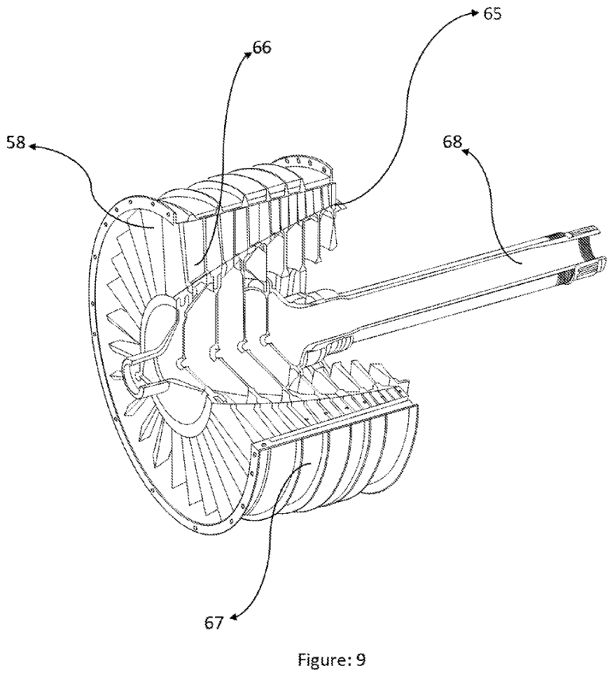

FIG. 9 illustrates an innovative Transonic/Conventional Axial Flow Compressor, representing a cutting-edge solution meticulously designed for optimal aerodynamic efficiency, reliability, and total pressure output. The figure visually emphasizes the strategic induction of Prandtl-Meyer expansion waves (65, 60, 7) and oblique shockwaves (4, 62, 39, 40) to minimize energy losses and address flow challenges, including boundary layer separations and turbulences.

The defined blading system (67) within the Transonic/Conventional Axial Flow Compressor is depicted, highlighting its role in achieving radial uniformity and reducing reliance on high differential stagger angles. This configuration not only mitigates axial velocity reduction but also enhances static pressure output, contributing significantly to overall system efficiency.

Additionally, the rotor blades in this defined Transonic/Conventional Axial Flow Compressor feature an innovative design that effectively addresses tonal nodes, tip leakages, pressure losses, corner drags, horseshoe vortices, and adverse pressure gradients. The result is a substantial improvement in efficiency and overall performance for the transonic/conventional axial flow compressor.

Furthermore, the implementation of a key and hole configuration ensures a secure attachment of stator blades, fortifying resistance to vibrations and reinforcing overall reliability. This figure encapsulates the key features and benefits of the described Transonic/Conventional Axial Flow Compressor.

### DETAILED DESCRIPTION

Axial flow compressors have the major applications in
gas turbine jet engines:
   Aeroderivative power plants for fixed wing & rotor wing aircrafts.
   Marine propulsion power plants.
   The industrial power generation & solutions.

The end users/operators are airliners, ocean liners, freight carriers (both aviation & marines), power generation companies & for industrial power solutions.
axial flow compressor as a product in:
   Oil & Gas Industry.
   Steel processing & production industries.
   The customers for high volume flow industrial application axial flow compressors like blast furnace blowers, propane dehydrogenation, synthetic flue processing, air separation, nitric acid plants, Fluid Catalytic Cracking (FCC) process.

The inlet diffuser combined with nacelle of the engine, LPC (low pressure compressor) is also called incoming air flow booster which is run by LPT (low pressure turbine) is connected through a shaft in between, then the HPC (high pressure compressor) is run by HPT (high pressure turbine), is connected through a shaft in between, a combustion chamber is present in between compressors and turbines, fuel will be added from the fuel tanks/reservoirs through fuel pipelines by fuel injectors/atomisers mounted inside the combustion chambers in multiple radial locations of the incoming flow of highly pressurized from compressors, the igniters/spark plugs continuous spark is placed inside the combustion chamber, the combustion chamber is designed to slow the flow to allow the fuel to mix with the flow properly and to cool the outer layer of the combustion chamber with the incoming flow as well. The highest temperature of an engine is inside the combustion chamber. The exhaust gasses from the combustion chamber outlet point will pass into turbine sections to drive the turbine. The different turbines like LPT,HPT,Turbine of the turbofans rotates all the upstream rotating components by partially expanding the gasses and extracting the power out of it to run all the upstream components. The flow from the turbine outlet will escape to the atmosphere through the nozzle exit, where the highly energized hot gasses expand fully. The ratio of mass flow rate through the turbofan to the mass flow rate through the core of the engine is called bypass ratio of an engine. The core of a gas turbine jet engine comprises HPC, Combustion chamber and HPT. Generally, the direction of rotations of the axial compressors and turbines is identified by the pressure concave side and suction convex side of the turbomachinery blades. If the rotating blades of a turbomachinery component rotates from the convex side to concave side, it will work as a compressor, work on the fluid vice versa, if it rotates from concave side to convex side of the blade, it will work as a turbine, extraction of work from the fluid. The axial compressor of a gas turbine jet engines comprises of plurality of rotor aerodynamic blades and stator aerodynamic blades alternatively. A set of rotor blades mounted on a rotor disc and a set of stator blades mounted on the case of the compressor is called a single stage.

Flow Over the Diamond Airfoil & its Derivatives to Diffuse the Flow with a Higher CPR and Velocity at the Outlet:

The diamond aerofoil design dynamically responds to varying free stream flow conditions, inducing compressed accelerated flow with high AVDR. In supersonic flow, leading oblique shocks are controlled by a specially designed converging flow path with bumps, minimizing losses, turbulence, and boundary layer separations. Expansion waves facilitate total pressure recovery. A delayed trailing oblique shockwave reduces energy losses and turbulent interactions. Bumps on diamond airfoils weaken leading-edge shockwaves, minimizing boundary layer separations. This design optimizes total pressure, reduces disturbances, and outperforms conventional stator blades, ensuring efficient diffuser operation. Its innovation enhances stability, efficiency, and mitigates surge and stall risks in compressor operation.

### Compression Pressure Ratio (CPR) & Gas Dynamics/Flow of Air Through the Compressor (Through Rotors and Stators):

In our novel axial flow compressor, air enters through the inlet and passes through inlet guide vanes (IGVs) into the first rotor stage, maintaining a zero angle between the flow and the central axis. The rotor-stator interaction ensures a smooth, non-distorted flow, eliminating the need for highly differential stagger angles. This results in enhanced velocity, increasing flow rate, Axial Velocity Density Ratio, and Ram Effect. Improved Ram Effect contributes to a higher thrust-to-weight ratio. Additionally, a slight decrease in entry flow static pressure enhances total thrust.

### General Thrust of the Engine:

Thrust is a mechanical force to move the engine/anything engine intended to move forward, which is the change in momentum which follows Newton's Second Law of Motion, which is for every action there is an equal and opposite reaction.

$$F = {m}_{e}^{.} * {v}_{e}^{.} - {m}_{0}^{.} * {v}_{0}^{.} + ( {p}_{e} - {p}_{0} ) {A}_{e}$$

Here, F is the Thrust or net force by the engine, me is the exit mass flow rate, v_{ė} is the exit velocity of the flow. m_{\dot{0}} is the entry mass flow rate of the air; v_{\dot{0}} is the entry mass flow of the air. pₑ is the static pressure at the exit, p₀ is the static pressure of the incoming air/entry flow and Aₑ is the cross section in which the flow leaves or expands in the engine/exit Nozzle area.

Higher Axial Velocity Density Ratio (AVDR) in our design enhances both velocity and static pressure, leading to increased mass flow rate and overall efficiency for downstream components. A slight decrease in inlet velocity and static pressure results in a larger capture area, reducing flow distortions and inlet drag. The higher exit static pressure and lower inlet static pressure contribute to improved thrust, substantially enhancing overall engine performance with reduced drag.

### Axial Velocity Density Ratio (AVDR):

The Axial Velocity Density Ratio (AVDR) serves as a crucial parameter for assessing the two-dimensionality of cascade flows. It plays a significant role in influencing both cascade performance and secondary flow structure. Variations in AVDR have a noteworthy impact on the loss characteristics of the cascade. An increase in AVDR effectively postpones the point of separation of the boundary layer over the blades. This, in turn, results in thinner boundary layers and induces a substantial reduction in the pressure loss coefficient.

In our technology, there has been a substantial improvement in AVDR throughout the compressor. This enhancement leads to a reduction in the pressure loss coefficient, accompanied by a delayed boundary layer separation point and the presence of thinner boundary layers.

### Compressor Stall & Surge:

The proposed compressor system, featuring diamond stator blades and their derivatives, is designed to mitigate inlet distortion, thereby enhancing the stall margin and reducing the likelihood of local stalls or surges. Stall, characterized by a disturbance in flow in the tangential direction, can be alleviated by implementing this innovative technology, which minimizes axial velocity reduction. This, in turn, helps maintain the engine's RPM at a certain percentage lower, effectively keeping it below the surge and stall margin while optimizing performance and efficiency.

In axial flow compressors, both stalling and surging represent unstable operational conditions. Stalling typically occurs when airflow separates from the convex sides of the compressor blades, indicating a mismatch between airflow and rotor speed. If left unaddressed, the stall can progress to a compressor surge. However, the novel technology ensures a continuous flow on both surfaces of the blades due to specific features, such as identical bumps on both sides of the diamond blades and delayed shock compression. These features contribute to a more stable and efficient compressor operation, minimizing the risk of stall and surge occurrences.

### Combustion Efficiency:

Non-distorted flow is critical for optimal combustion in a jet engine. Here's how it contributes to combustion efficiency:

Uniform Fuel Distribution: Non-distorted flow ensures a consistent and uniform distribution of fuel throughout the combustion chamber. This is essential for achieving a well-mixed fuel-air ratio, promoting complete combustion.

Stable Flame Front: A uniform flow of air and fuel supports the stability of the flame front. It helps prevent flame blowout or flashback, where the flame extinguishes or travels back into the fuel system, ensuring continuous and controlled combustion.

Efficient Energy Release: Uniform airflow patterns contribute to a more controlled and predictable combustion process. This, in turn, leads to a more efficient release of energy from the combustion of fuel, maximizing thrust and overall engine performance.

Reduced Emissions: Distorted flow can lead to incomplete combustion and the production of harmful emissions. Non-distorted flow promotes complete combustion, reducing the emission of pollutants and improving the environmental performance of the jet engine.

Temperature Control: Well-distributed airflow helps maintain consistent temperatures within the combustion chamber. This is crucial for preventing hot spots or areas with insufficient temperature, which can affect the engine's structural integrity and performance.

Enhanced Combustion Stability: Non-distorted flow contributes to overall combustion stability. It helps avoid fluctuations and irregularities in the combustion process, ensuring reliable engine operation across various operating conditions.

### Overall Gas Turbine Efficiency and the Impact on Downstream Components Like Turbine & Nozzle:

The advancements introduced by the ABMP Compressor offer several benefits to both the turbine and nozzles of the Gas Turbine Jet Engine:

Improved Efficiency: The innovative compressor design enhances overall gas turbine efficiency. Higher compression pressure ratios and reduced losses contribute to better energy extraction from the combustion process, optimizing turbine performance.

Stall and Surge Mitigation: The ABMP Compressor helps mitigate stall and surge risks, ensuring stable and efficient operation. This stability extends to the turbine, preventing disruptions in airflow that could negatively impact turbine blades.

Enhanced Combustion Efficiency: The non-distorted flow characteristics of the ABMP Compressor positively influence combustion efficiency. A more uniform and controlled airflow entering the combustion chamber facilitates better fuel-air mixing, leading to improved combustion and, consequently, enhanced turbine efficiency.

Optimised Operation Across Conditions: The design allows for strategic adjustments, such as refining blade edges and adjusting the angle of attack, offering flexibility and optimization for various operating conditions. This adaptability benefits both the turbine and nozzles, ensuring optimal performance under different load and environmental conditions.

Reduced Wear and Tear: The stable and efficient operation resulting from ABMP technology contributes to reduced wear and tear on turbine components. This can lead to extended operational life and decreased maintenance requirements.

Overall System Performance: The advancements in compressor technology have a cascading effect on the entire gas turbine system. Improved efficiency and stability in the compressor positively impact the downstream components, including the turbine and nozzles, resulting in an overall enhancement of jet engine performance.

### Impact on Sustainable Aviation Fuels and Hydrogen Propulsion:

The ABMP Compressor brings remarkable advancements to gas turbine performance. Its non-distorted flow characteristics enhance combustion efficiency, making it conducive for sustainable aviation fuels (SAF) and hydrogen. The compressor's adaptability, stall prevention, and optimized compression ratios ensure efficient operation with alternative fuels, reducing emissions and supporting environmental goals. The ABMP Compressor stands as a pivotal technology, contributing to the aviation industry's transition to cleaner and more sustainable fuel sources.

### Turbofans:

The innovative blading system can be seamlessly integrated into turbofan rotors and stators. The ABMP devices, strategically positioned between the stator blades, altogether facilitates a non-distorted flow, resulting in elevated pressure and outlet velocity. The implementation yields a substantial reduction in various factors, including vibrations, stresses on rotor blades, top and tip stresses of rotor blades, blade excitations, the turbulence, air molecules-extended blade surface interactions and other energy losses related to shockwaves, velocity deficit of wakes, and acoustic levels. These reductions with a higher pressure and exit velocity contributes to the redirection of a more uniform mass flow rate to the engine, thereby significantly decreasing nacelle drag and overall engine drag.

The robust stress limit capacity of both rotors and stators, coupled with enhanced output at lower RPMs when compared to conventional axial flow compressor subcomponents, enables turbofans to operate at significantly higher RPMs without necessitating extra precautions. This operational advantage translates into increased thrust and fuel efficiency at lower RPMs, marking a noteworthy improvement over traditional configuration.

### Effects on Instabilities of Axial Flow Compressors:

Innovative axial flow compressor technology addresses instabilities like rotating stalls, local stalls, and surge, crucial for overall gas turbine engine stability. The axial compressor's stable performance determines the stable operation of downstream components, impacting the engine's efficiency and performance.

The compressor operates within a surge margin, a narrow band around the design point ensuring stability and high efficiency. The novel blading system and device introduced in this technology enhance efficiency, allowing the engine to operate more efficiently at lower mass flow rates near the surge line. This broadens the operational range between surge and normal operating lines.

At higher mass flow rates, the technology generates higher pressure through shockwave compression with total energy recovery. The new blading system reduces stress and vibrational levels. Overall, this innovative technology extends the upper and lower operational limits of compressors, contributing to enhanced engine stability and efficiency across varying operating conditions.

1: A symmetrical diamond blade (47) specifically engineered for transonic/conventional axial flow compressors (59) to be utilised as both rotor blades (52,44,64,22) and stator blades (12,63,53,46) featuring a cross-section defined by a symmetrical diamond airfoil (2) and an imaginary straight chord line (1). Meticulously designed to optimize aerodynamic efficiency, this blade is intended for use in transonic/conventional axial flow compressors configured to seamlessly operate across subsonic (3) to supersonic flow conditions (8). The innovative design facilitates controlled flow acceleration through the precise induction of a Prandtl-Meyer expansion wave (7,59,60) at the maximum thickness point of the blade (61). Subsequent flow compression is achieved via a meticulously orchestrated oblique shockwave (4,39,62) emanating from the trailing edge of the blade. The integrated design ensures efficient flow compression while minimizing energy losses.
when employed as non-rotating or stator blades, is designed to achieve minimized flow distortion and enhance total pressure output by mitigating flow losses, consequently leading to a reduced reduction in axial velocity and higher static pressure output.
when utilized as rotating or rotor blades, is intricately designed to achieve minimal flow distortion and to augment total pressure output by effectively mitigating flow losses.

2: An elongated cantilever aerodynamic blade which is a continuous blade structure is characterized by a cross-section shaped as a diamond airfoil (2) or the geometry of the structure is defined as the axially opposed double triangular prisms merging at its imaginary base (22,12,63,64,48,52,53,44,46) wherein its free horizontal tip converges with a segment of a double cone (26,14,34,15).
The horizon, in this context, is defined as the plane that is parallel to the plane containing the axis of rotation (27,36,32,16).
The double cone, in this context, is specified as a continuous structure of an axially opposed double cones merging at their imaginary bases.
The segment of the double cone in this context is formed from truncating it by an imaginary plane parallel to its plane of the axis where the line of its heights exists (26,14,34,15).
The imaginary plane (27,36,32,16) in which the merge of the defined cantilever blade structure (28,12,63,64) and the defined segment of the defined double cone (26,14,34,15) is the same plane (24,14) formed by defined truncation of the double cone and the plane where the straight chord line of the cantilever blade structure meets the imaginary line of which passes through both vortices of the maximum thickness line (16,27,36).
Both the defined cantilever blade structure (28,12,63,64) and the identified segment of the double cones (26,14,34,15) seamlessly merge at the designated defined imaginary planes (27,36,32,16).
The combined structures form a continuous cantilever blade structure, generating a converging-diverging effect on the surrounding flow. This design results in superior aerodynamic efficiency and enhanced total pressure output by minimizing energy losses, including mitigating boundary layer separations and turbulences.

3: The blade structure of claim 2, wherein used as non-rotating blades or stator blades (54,53,63,12,46) with different lengths to reduce the hub solidity of the flow path of transonic/conventional axial flow compressors.

4: The blade structure of claim 2, wherein used as rotating or rotor blades (22,64,52,48,44,58) with optimized length of the blade at the throat section of the flow path volume and minimum length of the blade at the leading and trailing edges. This design reduces tonal nodes, tip leakages, pressure losses, corner drags, horseshoe vortices, and adverse pressure gradients, resulting in improved efficiency and performance in a transonic/conventional axial flow compressor.

5: The Blade structure, as described in claim 1 incorporating with an additional feature as
The cross-sectional diamond airfoils of the blades vary in proportion between the two opposing imaginary triangles of the diamond airfoil and its total size varies for different radial locations from the hub to the tip. This variation is attributed to the radial velocity gradient, which is decreasing from the tip to the hub for a rotor (63,31) and vice versa for a stator (64,18). This specialized configuration results in an amplified acceleration of the magnitude of velocity without changing the vector associated, promoting uniformity across radial locations from the hub to the tip. Consequently, the adoption of this blade structure significantly reduces the necessity for high differential stagger angles throughout the radial locations by bringing a flow uniformity over different radial locations.

6: The blade structure as described in claim 2, claim 3 and claim 4 incorporating with additional features like
for the defined continuous blade structure which have a geometry of an axially opposed based merged double triangular prisms (63,64), the cross-sectional diamond airfoils of these defined continuous blade structures, the proportion between the two opposing imaginary triangles of the diamond airfoil and its total size varies for different radial locations from the hub to the tip (31,18). This variation is attributed to the radial velocity gradient, which is decreasing from the tip to the hub for a rotor (64) and vice versa for a stator (63). This is due to the high requirement of flow acceleration at the hub and low demand at the tip of the blade structure. This specialized configuration results in an amplified acceleration of the magnitude of velocity without changing the vector associated, promoting uniformity across radial locations from the hub to the tip. Consequently, the adoption of this blade structure significantly reduces the necessity for high differential stagger angles throughout the radial locations by bringing a flow uniformity over different radial locations.

7: The hub and tip walls of both the rotors and stators sections are designed with an initial positive slope extending to a minimum throat cross-sectional area, followed by a negative slope after the minimum throat, resulting in a horizontal converging-diverging flow path between the rotor blades and stator blades (44,46,50,51,49,10,29,19) This specific configuration is intended to minimize energy losses and facilitate wake dilution, allowing for total energy recovery through the effective straining over incoming wakes at the high-velocity field of the throat. The utilization of converging-diverging flow paths enhances the overall efficiency of the system.

8: The blade structure as described in claim 3 employs a key and hole configuration (54,56,57). This configuration is defined by the perfect fit of the tip of the stator blade (56) over the hub surface (57), which is achieved through a void formed by a positive slope, followed by a minimum length point, and then a negative slope on the stator blade tips (56) and an overage formed due to vice versa over the hub surface (57). This meticulous arrangement ensures a secure attachment of stator blades to the hub surface (56,57). The designed configuration not only enhances resistance to vibrations but also effectively dampens effects during blade fluttering, thereby contributing to increased reliability in axial flow compressors and gas turbine jet engines.

9: A converging-diverging flow process achieved by placing the blade structures (38,59,39) defined in claim 1, claim 2, claim 3, claim 4, claim 5, claim 6, claim 8 and the flow path described in claim 7 (50,51), which is to reduce flow losses and to enhance the total pressure output in a flow in between the Compressor rotor and stator blades by featuring
the convergence of the flow which accelerates the flow to a maximum velocity gradient at the throat (65) of the consecutively placed blades, moreover, for a near sonic flow entry, a cross combination of Prandtl-Meyer expansion wave forms at this location (65). This process accelerates the low momentum fluids and it forms a strong velocity field (65) which imposes strains over the incoming wakes of the flow results in a well-structured total pressure recovery. in addition to that, for a supersonic flow entry, this process will weaken the strength of the leading-edge shockwaves (38), further reduces the flow distortion, disturbances, turbulences and energy losses.
then the flow converges to form the delayed oblique shock waves in cross arrangement (39,40) in between the diamond blades.

10: An Axial flow compressor comprises of the
blade structures described in claim 1, claim 2, claim 3, claim 4, claim 5, claim 6, claim 7 and claim 9.
Flow path described in claim 8.
Describes an innovative Transonic/Conventional Axial Flow Compressor which results in a cutting-edge solution meticulously crafted for optimal aerodynamic efficiency, reliability, and total pressure output. Through the strategic induction of Prandtl-Meyer expansion waves (65,60,7) and oblique shockwaves (4,62,39,40), this design effectively minimizes energy losses and tackles various flow challenges, such as boundary layer separations and turbulences. Notably, this approach not only mitigates axial velocity reduction but also elevates static pressure output. The defined blading system within the Transonic/Conventional Axial Flow Compressor (67) contributes significantly to overall system efficiency by achieving radial uniformity, thereby reducing the reliance on high differential stagger angles. in addition to that, the rotor blades in this defined Transonic/Conventional Axial Flow Compressor boast an innovative design which effectively mitigates tonal nodes, tip leakages, pressure losses, corner drags, horseshoe vortices, and adverse pressure gradients. The result is a substantial improvement in efficiency and overall performance for the transonic/conventional axial flow compressor. Furthermore, the implementation of a key and hole configuration ensures a secure attachment of stator blades, fortifying resistance to vibrations and reinforcing overall reliability.
